(19) United States
(12) Patent Application Publication
(10) Pub. No.: US 2005/0244241 A1
(43) Pub. Date: Nov. 3, 2005

(54) Cooling system, cooling method, and electronic apparatus

(76) Inventors: Joichi Miyazaki, Chiba-shi (JP); Keishi Honmura, Chiba-shi (JP); Ko Yamazaki, Chiba-shi (JP); Fumiharu Iwasaki, Chiba-shi (JP); Tsuneaki Tamachi, Chiba-shi (JP); Takafumi Sarata, Chiba-shi (JP); Norimasa Yanase, Chiba-shi (JP); Toru Ozaki, Chiba-shi (JP)

Correspondence Address: BRUCE L. ADAMS, ESQ., 31ST FLOOR, 50 BROADWAY, NEW YORK, NY, 10004, US

(21) Appl. No.: 11/109,093

(22) Filed: Apr. 19, 2005

(30) Foreign Application Priority Data
Apr. 30, 2004 (JP) 2004-135848
Apr. 30, 2004 (JP) 2004-135849

(51) Int. Cl. H01M 8/04; F02G 1/00

(52) U.S. Cl. 410/66

(57) ABSTRACT

Disclosed are a cooling system, a cooling method, and an electronic apparatus which easily allow a reduction in size and which help to achieve an improvement in terms of energy efficiency. The cooling system uses a liquid constituting a fuel of a fuel cell as a cooling medium.

### BACKGROUND OF THE INVENTION

1. Field of the Invention

The present invention relates to a cooling system, a cooling method, and an electronic apparatus.

2. Description of the Related Art

Conventionally, as an example of a cooling system, there exists a water cooling system composed of a duct for circulating cooling medium, a heat absorbing device (a heat absorbing radiator) and a heat dissipating device (a heat dissipating radiator) which are arranged in the duct. In the vicinity of the heat absorbing device, there is arranged an apparatus to be cooled (for example, a vehicle engine or a computer CPU). Heat emanating from the apparatus to be cooled is absorbed by the heat absorbing device, and that heat heats the cooling medium, which is cooled by the heat dissipating device.

Recently, a fuel cell has been attracting attention as a clean power source. A fuel cell is a device that produces electrical energy from hydrogen and oxygen through chemical reaction. For example, there exists a direct methanol type fuel cell that effects power generation by supplying an aqueous solution of methanol directly to a power generation stack. The direct methanol type fuel cell, which is of a simple structure and easily allows a reduction in size and weight, is attracting attention as the power source of a mobile phone, a notebook personal computer, or the like (see, for example, JP 2004-55474 A). Further, there has been conceived a fuel cell equipped with a fuel cell structure in which an anode side electrode and a cathode side electrode are arranged so as to be opposed to each other with an electrolyte membrane therebetween, and separators holding the fuel cell structure therebetween (see, for example, JP 10-55812 A).

However, the above-mentioned conventional cooling system requires at least a duct for circulating cooling medium, a pump, a heat absorbing device, and a heat dissipating device, and lacks a technical idea to utilize the components of a power generating means (a power source device). Further, the above-mentioned conventional fuel cell requires at least a duct for circulating fuel, a pump, and a fuel cell structure, and lacks a technical idea to form a cooling system by utilizing the components of the fuel cell.

Thus, in the prior-art technique, when, for example, a fuel cell is used as the power source of a personal computer, and a water cooling system is used to cool the CPU of the personal computer, it is necessary to provide a duct, a fuel tank, and a radiator for the fuel cell, and a duct, a refrigerant tank, and a radiator for the water cooling system. Thus, in the prior-art technique, an attempt to form a device using the fuel cell and water cooling device mentioned above leads to an increase in the number of parts, resulting in an increase in apparatus size and production cost. Further, such a conventional device has a problem also in terms of energy efficiency due to the increase in the number of parts, the wasteful consumption of a large amount of heat energy, etc.

### SUMMARY OF THE INVENTION

The present invention has been made in view of the above problems in the prior art. It is an object of the present invention to provide a cooling system, a cooling method, and an electronic apparatus which allow cooling by utilizing the components of a power generating means.

Another object of the present invention is to provide a cooling system, a cooling method, and an electronic apparatus which can exert a power generating function and a cooling function and which easily allow a reduction in size.

Still another object of the present invention is to provide a cooling system, a cooling method, and an electronic apparatus which easily allow a reduction in size and which help to achieve an improvement in energy efficiency.

To achieve the above objects, the present invention provides the following means.

The present invention provides a cooling system which uses a fuel of a fuel cell as a cooling medium.

In the cooling system according to the present invention, the apparatus to be cooled can be cooled by using the fuel of a fuel cell as the cooling medium. That is, according to the present invention, the apparatus to be cooled (e.g., CPU) is cooled by using, for example, methanol as the fuel, and while doing so, it is possible to generate power by using that methanol. Thus, in the present invention, the same thing serves as both the cooling medium and the fuel of the fuel cell, and the flow passage for the cooling medium and the flow passage for the fuel can share a common structure. More specifically, the tank, flow passage, pump, etc. of the cooling means, and the tank, flow passage, and pump, etc. of the power generating means can be commonly used by the cooling means and the power generating means. Thus, according to the present invention, it is possible to provide a cooling system which, while equipped with a power generating means and a cooling means, can realize simplification of the components and a reduction in size and installation space. Further, according to the present invention, the fuel of the fuel cell is cooled, so that the pump can be shared by the cooling means and the fuel cell, making is possible to provide a cooling system of high energy efficiency and having a power generating means.

Further, the present invention provides a cooling system, including: a heat collector using the fuel as the cooling medium; a power generation stack constituting the fuel cell; and a fuel flow passage which constitutes a flow passage for the fuel and which connects at least the heat collector and the power generation stack.

In the cooling system according to the present invention, the apparatus to be cooled (e.g., CPU) is arranged in the vicinity of the heat collector, whereby it is possible to cool the apparatus by means of the fuel. Further, it is possible to generate power by the fuel used (or to be used) for the cooling. Thus, in the present invention, it is also possible to generate power while cooling the apparatus to be cooled, and to supply the generated power to the apparatus to be cooled. Thus, in the present invention, it is possible to provide a cooling system with a power generating means, which can reduce the number of parts, thereby achieving a reduction in size and enhancing the energy efficiency.

Further, the present invention provides a cooling system, further including a pump which moves the fuel in the fuel flow passage.

In the cooling system according to the present invention, it is possible to move the fuel from the heat collector to the power generation stack or from the power generation stack to the collector by means of the pump. Thus, the pump can be shared by the cooling means and the fuel cell.

Further, the present invention provides a cooling system, in which the heat collector is arranged on the upstream side of the power generation stack with respect to a fuel flow in the fuel flow passage.

In the cooling system according to the present invention, it is possible to supply the fuel heated by the heat collector to the power generation stack. Thus, in the present invention, the heat energy recovered by the cooling means is effectively utilized, and the heated fuel can be supplied to the fuel cell, making it possible to achieve the power generation efficiency of the power generation stack. Further, according to the present invention, the heated fuel can be supplied to the fuel cell, so that it is possible to shorten the power generation start time for the power generation stack. Here, the power generation start time refers to the period of time from the start of fuel supply to the power generation stack to the time when the power generation stack starts to output a predetermined power.

Further, the present invention provides a cooling system, further including a control means which controls an operation of the pump, in which, when a cooling operation by the heat collector is required, the control means drives the pump (the cooling system has an on-demand function).

In the cooling system according to the present invention, when, for example, the apparatus to be cooled (CPU) is operated, the apparatus to be cooled is heated, so that a cooling operation is required. When this requirement occurs, it is necessary to supply power to the apparatus to be cooled, so that, by driving the pump at this time, it is possible to effect cooling while performing power generation. Thus, according to the present invention, it is possible to provide a cooling system with an on-demand function by which cooling and power generation are effected upon occurrence of at least one of cooling requirement and power generation requirement.

Further, the present invention provides a cooling system, further including a reservoir tank that stores the fuel, in which the fuel passage constitutes a flow passage connecting the reservoir tank, the heat collector, and the power generation stack in series, and constitutes a circulation flow passage that causes the fuel to circulate through the reservoir tank, the heat collector, and the power generation stack.

In the cooling system according to the present invention, the fuel stored, for example, in the reservoir tank is supplied to the heat collector, and that fuel is supplied from the heat collector to the power generation stack, in which the surplus fuel in the power generation stack can be restored to the reservoir stack. Thus, the cooling system of the present invention can efficiently use the fuel for power generation and cooling.

Further, the present invention provides a cooling system, further including: a fuel tank that stores the fuel supplied to the reservoir tank; a supply flow passage connecting the fuel tank and the reservoir tank; and a supply pump arranged in the supply flow passage.

In the cooling system according to the present invention, the fuel stored in the fuel tank can be supplied to the reservoir tank. Thus, when the amount of fuel in the reservoir tank becomes small as a result of the fuel consumption in the power generation stack, it is possible to replenish the reservoir tank with fresh fuel.

Further, to achieve the above objects, the present invention provides the following means.

The present invention provides an electronic apparatus including the cooling system.

In the electronic apparatus according to the present invention, it is possible to provide, for example, a fuel cell as the power source and to cool the heat generating element, such as a CPU, by the fuel of the fuel cell. Thus, according to the present invention, it is possible to provide an electronic apparatus which has a heat generating means and a cooling means and which allows a reduction in size and production cost. For example, according to the present invention, it is possible to promote an increase in speed and scale of integration of a CPU as an apparatus to be cooled, making it possible to make compact the cooling means for cooling the CPU and the power generating means for supplying power to the CPU. Thus, according to the present invention, it is possible to achieve a reduction in the size and price of an electronic apparatus, such as a notebook personal computer or a mobile phone, as compared with the prior art while improving the performance thereof.

Further, the present invention provides an electronic apparatus, including: an apparatus to be cooled that is arranged in the vicinity of the heat collector; and an electronic device that is operated by using an electric power output from the power generation stack. Preferably, the apparatus to be cooled and the electronic device are the same member.

In the electronic apparatus according to the present invention, the apparatus to be cooled, such as a CPU, is cooled by the fuel, and while doing so, it is possible to continue to drive the apparatus to be cooled with the power generated by the fuel. Further, according to the present invention, when there is no need to cool the apparatus to be cooled, that is, when the CPU or the like is at rest, there is no need to supply fuel to the power generation stack, so that it is possible to reduce wasteful fuel consumption and wasteful pump operation, making it possible to use the fuel more efficiently.

Further, the present invention provides an electronic apparatus, in which the cooling system is detachably mounted to a main body of the electronic apparatus.

In the electronic apparatus according to the present invention, when, for example, the cooling system according to the present invention has run out of fuel or is out of order, a new cooling system according to the present invention is mounted to the electronic apparatus main body, whereby it is possible to effect troubleshooting quickly and easily. Further, when there is no need for the cooling system of the present invention (for example, when the CPU is operated at low speed), the cooling system of the present invention is detached, thus allowing the electronic apparatus to be easily carried about.

Further, to achieve the above objects, the present invention provides the following means.

A cooling method in which a fuel of a fuel cell is used as a cooling medium.

In the cooling method according to the present invention, it is possible to cool an apparatus to be cooled, such as a CPU, by using the fuel of a fuel cell as the cooling medium. As the cooling medium, a liquid substance, such as methanol is preferable; however, it is also possible to use a fuel in the form of a gas or a liquid. Further, according to the present invention, the same thing can be used as both the cooling means and the power generating means, making it possible to provide a cooling method which allows simplification of the components and a reduction in size and installation space. Further, in the cooling method of the present invention, cooling is effected by the fuel of the fuel cell, thereby achieving an enhancement in energy efficiency.

Further, the present invention provides a cooling method, in which the fuel, which is used as the cooling medium and heated, is supplied to a power generation stack constituting the fuel cell.

In the cooling method according to the present invention, it is possible to heat the fuel by effectively utilizing the heat energy of the apparatus to be cooled, making it possible to improve the power generation efficiency of the power generation stack. Further, according to the present invention, it is possible to supply a fuel at high temperature to the fuel cell by effectively utilizing the heat energy of the apparatus to be cooled, making it possible to shorten the power generation start time for the power generation stack.

Further, the present invention provides a cooling method, in which the fuel is circulated through a heat collector using the fuel as the cooling medium and through the power generation stack.

In the cooling method according to the present invention, it is possible to circulate fuel, for example, between the reservoir tank, the collector, and the power generation stack, making it possible to efficiently use the fuel for power generation and cooling.

Further, the present invention provides a cooling system which uses a fuel of a fuel cell as a cooling medium, including: a heat collector through which the fuel passes as the cooling medium; a cooling flow passage constituting a flow passage for supplying the fuel to the heat collector; a power generation stack to which the fuel is supplied and which constitutes the fuel cell; and a power generation flow passage constituting a flow passage for supplying the fuel to the power generation stack. Here, the cooling flow passage and the power generation flow passage may be provided in parallel.

In the cooling system according to the present invention, it is possible to cool the apparatus to be cooled arranged in the vicinity of the heat collector (cooling means) by using the fuel of the fuel cell (power generating means) as the cooling medium. That is, in the cooling system of the present invention, it is possible to cool the apparatus to be cooled with the fuel of the fuel cell and, while doing so, to generate power with the same fuel. Thus, in the present invention, the same thing can be used as both the cooling medium and the fuel of the fuel cell, and the flow passage, etc. for transporting the fuel can be shared by the cooling means and the power generating means. Thus, according to the present invention, it is possible to easily provide a cooling system which allows a reduction in size and installation space while having a power generating means and a cooling means. Further, the cooling system of the present invention, which thus allows a reduction in size, can reduce the energy loss for transporting the fuel, thereby achieving an improvement in energy efficiency.

Further, the present invention provides a cooling system, further including a radiator arranged on the downstream side of the heat collector in the cooling flow passage, in which the radiator is arranged in the vicinity of the power generation stack.

In the cooling system according to the present invention, it is possible to heat the power generation stack with the heat emitted from the radiator, making it possible to improve the power generation efficiency of the power generation stack. Further, generally speaking, the power generation stack effects power generation in a stable manner at a temperature higher than room temperature, so that it is possible to shorten the power generation start time for the power generation stack. Here, the power generation start time refers to the period of time from the start of fuel supply to the power generation stack to the time when the power generation stack starts to output a predetermined power.

Further, the present invention provides a cooling system, further including: a pump that moves the fuel; and a branching portion that branches off the fuel moved by the pump in at least two directions, in which an upstream end of the cooling flow passage is connected to a first branching end of the branching portion, and in which an upstream end of the power generation flow passage is connected to a second branching end of the branching portion.

In the cooling system according to the present invention, the fuel can be supplied to both the cooling flow passage and the power generation flow passage by a single pump. Thus, the pump can be shared by the cooling means and the power generating means, thereby achieving a further reduction in size.

Further, the present invention provides a cooling system, in which the cooling flow passage constitutes all or a part of a circulation flow passage through which the fuel is circulated at least through the heat collector, and in which the power generation flow passage constitutes all or a part of a circulation flow passage through which the fuel is circulated at least through the power generation stack.

In the cooling system according to the present invention, the fuel can be circulated through both the cooling flow passage and the power generation flow passage. Thus, the cooling system according to the present invention can effectively utilize the fuel without wasting it, thus making it possible to provide a cooling system of a still higher energy efficiency.

Further, the present invention provides a cooling system, further including a reservoir tank storing the fuel and equipped with an outlet port through which the fuel stored flows out, in which the outlet port of the reservoir tank is connected to an inlet port of the pump.

In the cooling system according to the present invention, the reservoir tank can be shared by the cooling means and the power generating means. Thus, according to the present invention, it is possible to provide a cooling system which is further reduced in size and improved in performance while having a power generating means and a cooling means.

Further, the present invention provides a cooling system, in which the reservoir tank has a plurality of inlet ports, a downstream end of the cooling flow passage is connected to a first inlet port of the reservoir tank, and a downstream end of the power generation flow passage is connected to a second inlet port of the reservoir tank.

In the cooling system according to the present invention, the reservoir tank can function as a means for joining the cooling flow passage and the power generation flow passage. Thus, according to the present invention, it is possible to provide a cooling system which is further reduced in size and improved in performance while having a power generating means and a cooling means.

Further, the present invention provides a cooling system, further including an air blower that supplies air to the radiator, in which the power generation stack is arranged on the downstream side of the radiator with respect to an airflow generated by the air blower.

In the cooling system according to the present invention, the air blower can be shared by the radiator of the cooling means and the power generation stack of the power generating means. Thus, according to the present invention, it is possible to provide a cooling system which is further reduced in size and improved in performance while having a power generating means and a cooling means.

Further, the present invention provides a cooling system, further including: a first valve arranged in the cooling flow passage; and a second valve arranged in the power generation flow passage.

In the cooling system according to the present invention, the supply/supply-stop of fuel to the cooling flow passage can be controlled by the first valve, and the supply/supply-stop of fuel to the power generation passage can be controlled by the second valve. It is only necessary for the first and second valves to be capable of opening/closing operation; the valves may also be ones capable of performing variable control on the fuel flow rate stepwise or smoothly. Further, the opening/closing and aperture of the first and second valves may be adjusted directly by manual operation, or their opening/closing and aperture may be adjusted by mechanical and electronic control means.

Further, the present invention provides a cooling system, in which the first valve is arranged on the upstream side of the heat collector in the cooling flow passage, and the second valve is arrange on the upstream side of the power generation stack in the power generation flow passage, the cooling system further including a control means that controls the opening and closing of the first valve and the second valve, and when cooling by the heat collector is not required, the control means closes the first valve, and when power generation by the power generation stack is not required, the control means closes the second valve.

In the cooling system according to the present invention, when there is no need to effect cooling, the first valve is closed, whereby almost all the fuel output from the pump can be used for power generation, thus increasing the power generation output. Further, when there is no need to effect cooling nor is there any need for the generated power to be particularly large, it is possible to close the first valve and to reduce the driving power for the pump. Further, in the cooling system of the present invention, when there is no need to effect power generation, the second valve is closed, whereby almost all the fuel output from the pump can be used for cooling, thus enhancing the cooling capacity. Further, when there is no need to effect power generation nor is there any need for the cooling capacity to be particularly large, it is possible to close the second valve and to reduce the driving power for the pump.

Further, the present invention provides a cooling system, further including: a fuel tank that stores the fuel to be supplied to the reservoir tank; a supply flow passage connecting the fuel tank and the reservoir tank; and a supply pump arranged in the supply flow passage.

In the cooling system according to the present invention, the fuel stored in the fuel tank can be supplied to the reservoir. Thus, in the cooling system of the present invention, when the amount of fuel in the reservoir tank is reduced as a result of the fuel consumption in the power generation stack, it is possible to replenish the reservoir tank with fresh fuel.

Further, to achieve the above objects, the present invention provides the following means.

An electronic apparatus according to the present invention has the above-mentioned cooling system.

In the electronic apparatus according to the present invention, a fuel cell, for example, is provided as the power source, and a heat generating element, such as a CPU can be cooled by the fuel of the fuel cell. Thus, according to the present invention, it is possible to provide an electronic apparatus which has a power generating means and a cooling means and which allows a reduction in size and production cost. Further, according to the present invention, it is possible to exert power generating function and cooling function with high energy efficiency, so that it is possible to provide an electronic apparatus involving low running cost. For example, according to the present invention, it is possible to promote an increase in speed and scale of integration of a CPU as an apparatus to be cooled, making it possible to make compact the cooling means for cooling the CPU and the power generating means for supplying power to the CPU. Thus, according to the present invention, it is possible to achieve a reduction in the size and price of an electronic apparatus, such as a notebook personal computer or a mobile phone, as compared with the prior art while improving the performance thereof.

Further, the present invention provides an electronic apparatus, further including: an apparatus to be cooled arranged in the vicinity of the heat collector; and an electronic device operating by using an electric power output from the power generation stack. Here, the apparatus to be cooled and the electronic device are preferably the same member.

In the electronic apparatus according to the present invention, the apparatus to be cooled, such as a CPU, is cooled by the fuel, and while doing so, it is possible to continue to drive the apparatus to be cooled with the power generated by the fuel. Further, according to the present invention, when there is no need to utilize the ability to generate power, for example, when use of commercial power is possible, it is possible to control the first valve and the second valve so as to exert the cooling function alone, thereby reducing the load on the pump and energy consumption. Further, according to the present invention, when there is no need to exert the cooling ability, for example, when the CPU is being driven at low speed or at rest, it is possible to control the first valve and the second valve so as to exert the power generating function alone. Any surplus power generated may be used to charge a storage battery or the like. Such a storage battery may be provided in the electronic apparatus of the present invention. Further, at the start of the electronic apparatus of the present invention, it is possible to supply power from the storage battery to the pump, CPU, etc. Due to these arrangements, according to the present invention, it is possible to reduce wasteful fuel consumption and wasteful pump operation, making it possible to use the fuel more efficiently.

Further, in the electronic apparatus of the present invention, the cooling system may be detachably mounted to the main body of the electronic apparatus. Thus, when, for example, the cooling system of the present invention has run out of fuel or is out of order, a new cooling system according to the present invention is mounted to the electronic apparatus main body, thereby effecting troubleshooting quickly and easily.

According to the present invention, it is possible to provide a cooling system, a cooling method, and an electronic apparatus which allow cooling by using the components of a power generating means.

Further, according to the present invention, it is possible to provide a cooling system, a cooling method, and an electronic apparatus which can exert a power generating function and a cooling function and which easily allow a reduction in size.

Further, according to the present invention, it is possible to provide a cooling system, a cooling method, and an electronic apparatus which easily allow a reduction in size and which help to achieve an improvement in energy efficiency.

### BRIEF DESCRIPTION OF THE DRAWINGS

In the accompanying drawings:

FIG. 1 is a conceptual drawing showing the construction of a cooling system according to a first embodiment of the present invention;

FIG. 2 is a perspective view of an outward appearance of an electronic apparatus according to the first embodiment of the present invention;

FIG. 3 is a schematic sectional view of the internal construction of the electronic apparatus of the first embodiment;

FIG. 4 is a conceptual drawing showing the construction of a cooling system according to a second embodiment of the present invention; and

FIG. 5 is a schematic sectional view of the internal construction of the electronic apparatus of the second embodiment.

### DESCRIPTION OF THE PREFERRED EMBODIMENTS

### FIRST EMBODIMENT OF THE INVENTION

(Cooling System)

In the following, a cooling system according to the present invention will be described with reference to the drawings.

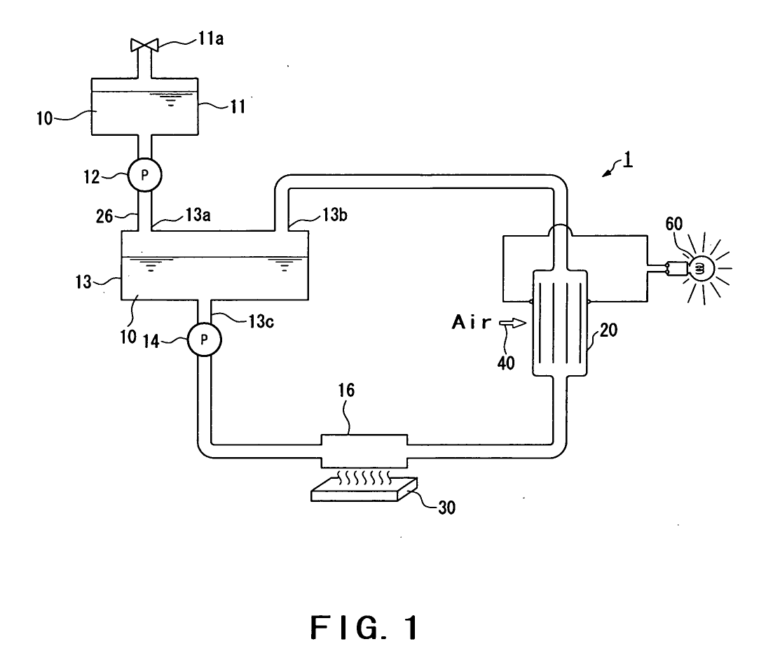

FIG. 1 is a conceptual drawing showing the construction of a cooling system according to a first embodiment of the present invention. The cooling system 1 uses the fuel of a fuel cell as the cooling medium. The cooling system 1 has a power generating means using a fuel cell, and a cooling means using fuel 10 of the fuel cell as the cooling medium. The construction of this cooling system will be described specifically.

The cooling system 1 has a fuel tank 11, a fuel supply pump 12, a reservoir tank 13, a fuel circulating pump 14, a heat collector 16, a power generation stack 20, a fuel flow passage 25, and a supply flow passage 26. Here, the reservoir tank 13, the fuel circulating pump 14, the heat collector 16, and the power generation stack 20 are connected in series in a loop by the fuel flow passage 25, forming a circulation path for the fuel 10. The fuel tank 11 is a tank for storing the fuel 10 of the fuel cell. The fuel tank 11 has an inlet port 11a for introducing the fuel 10 into the fuel tank 11. At the inlet port 11a, a valve or a stopper may be provided, connection to some other fuel supply device like a fuel tank being effected through the valve.

As the fuel 10 of the fuel cell, an aqueous solution of methanol is preferable. However, it is also possible to use some other fuel as the fuel 10 as long as it is one for a fuel cell; it may also be a liquid, a solution, or the like other than methanol. Examples of the fuel 10 that can be suitably used include methanol, sodium borohydride (NaBH₄), dimethylether, naphtha, biomass, and kerosene. It should be noted, however, that the construction of the power generation stack 20 must be changed according to the kind of the fuel 10, with the heat collecting effect of the heat collector 16 being also changed. An aqueous solution of methanol, which can be directly supplied to the power generation stack 20 to effect power generation and which provides a high heat collecting effect at the heat collector 16, is suitable as the fuel 10 of this embodiment.

The fuel supply pump 12 is a pump arranged in the supply flow passage 26 connecting the fuel tank 11 and the reservoir tank 13 and which serves to supply the fuel 10 in the fuel tank 11 to the reservoir tank 13. The operation of the fuel supply pump 12 is controlled by a control means (not shown) for this cooling system. When, for example, the level of the fuel 10 in the reservoir tank 13 becomes not higher than a predetermined value, the control means drives the fuel supply pump 12 to supply the fuel 10 to the reservoir tank 13.

The reservoir tank 13 is a tank which temporarily stores the fuel 10 supplied from the fuel tank 11 and which constitutes a part of the circulation flow passage (fuel flow passage) for the fuel 10 in the cooling system 1. That is, the reservoir tank 13 has an inlet portion 13a constituting an inlet port for the fuel 10 supplied from the fuel tank 11 through the fuel supply pump 12, an outlet portion 13c constituting an outlet port for the fuel 10 stored in the reservoir tank 13, and an inlet portion 13b constituting an inlet port for the fuel 10 supplied from the power generation stack 20.

The fuel circulation pump 14 is a pump which supplies the fuel 10 in the reservoir tank 13 to the heat collector 16 side. Thus, the fuel 10 is supplied from the reservoir tank 13 to the heat collector 16 by the fuel circulation pump 14, and is further supplied from the heat collector 16 to the power generation stack 20 before being further supplied from the power generation stack 20 to the reservoir tank 13 to circulate through the fuel flow passage 25.

The heat collector 16 constitutes a heat absorbing device (heat exchanger for heat absorption) using the fuel 10 as the cooling medium. The heat collector 16 may be arranged in the vicinity of an apparatus 30 to be cooled or in close contact with the apparatus 30 to be cooled. The apparatus 30 to be cooled is an apparatus to be cooled by the cooling system 1 and includes a heat generating device, such as the CPU of a personal computer or of a mobile phone. The apparatus 30 to be cooled is not restricted to a CPU; it may also be an integrated circuit of high density and high operating speed, a component of a projector serving as a display device, a mechanical component of a vehicle engine, etc.

The power generation stack 20 constitutes a fuel cell using the fuel 10 as the fuel. That is, various types of fuel cell are applicable as the power generation stack 20 as long as they constitute fuel cells. When a direct methanol type fuel cell (DMFC) is applied as the power generation stack 20, it is possible to adopt the following construction. The power generation stack 20 has a construction in which both sides of an electrolyte are held between negative and positive electrodes and bonded together, with an aqueous solution of methanol as the liquid fuel 10 being supplied to the negative electrode, and which includes a cell stack formed by stacking together a plurality of cells, to the positive electrode of which air 40 as oxidant gas is supplied. Further, inserted between the cells are separators with flow passages and manifolds for discharging a reaction product produced through electrochemical reaction in each cell.

Then, an aqueous solution of methanol is supplied to the negative electrode and air is supplied to the positive electrode of each cell of the power generation stack 20. Then, at the negative electrodes, the methanol and water undergo reaction to produce a carbon dioxide, and, at the positive electrodes, the oxygen in the air 40 takes in hydrogen ions and electrons transmitted through the electrolyte to produce water, with the result that electrical energy is generated between the positive and negative electrodes (i.e., power is generated). This electrical energy is output to an external circuit 60 electrically connected between the positive and negative electrodes. Any surplus fuel 10 in the power generation stack 20, that is, the portion of the fuel 10 which has not been used for power generation, is supplied to the reservoir tank 13.

Due to this arrangement, in the cooling system 1 of this embodiment, the fuel 10 for effecting power generation in the power generation stack 20 is used as a cooling medium at the heat collector 16, whereby it is possible to cool the apparatus 30 to be cooled. That is, the cooling system 1 is capable of effecting cooling in the heat collector 16 while performing power generation in the power generation stack 20. Further, in the cooling system 1, the fuel flow passage 25 can be commonly used as the flow passage for the cooling medium and the flow passage for the fuel, so that, as compared with the case in which the cooling means and the power generating means are separately provided, it is possible to simplify the components and to achieve a reduction in size and installation space. Further, in the cooling system 1, the sum total of the length of the refrigerant flow passage and the length of the fuel flow passage can be reduced as compared with the case in which the cooling means and the power generating means are separately provided, whereby it is possible to reduce loss of the energy consumed in the flow passages. In the cooling system 1, the power generated in the power generation stack 20 may be supplied to the apparatus 30 to be cooled. This makes it possible to achieve a further reduction in size for the electronic apparatus equipped with the apparatus 30 to be cooled, making it possible to utilize the fuel 10 still more efficiently.

Further, in the cooling system 1, the heat collector 16 is arranged on the upstream side of the power generation stack 20 in the fuel flow passage 25. Due to this arrangement, the fuel 10 heated at the heat collector 16 can be supplied to the power generation stack 20. Thus, in the cooling system 1, it is possible to heat the fuel 10 of the fuel cell by using the heat energy of the apparatus 30 to be cooled, which has conventionally been wastefully consumed. To stably obtain high output in the power generation stack 20, in the case of a methanol type fuel cell, it is desirable to operate it at an ambient temperature ranging from 30 to 90° C. Thus, in the cooling system 1, it is possible to effectively utilize the heat energy of the apparatus 30 to be cooled, achieving an improvement in power generation efficiency in the power generation stack 20 and to obtain high output in a stable manner. Further, in the cooling system 1, it is possible to supply the fuel 10 at high temperature to the power generation stack 20, whereby it possible to shorten the power generation start time in the power generation stack 20.

Further, the cooling system 1 has a control means for controlling the operation (start and completion) of the fuel circulating pump 14, and the control means may have an on-demand function by which the fuel circulating pump 14 is driven when cooling operation by the heat collector 16 is required. That is, it is when the apparatus 30 to be cooled is operating and generating heat that cooling operation is required in this embodiment. Further, in the case in which power generated in the power generation stack 20 is supplied to the apparatus 30 to be cooled, it is when the apparatus 30 to be cooled is being operated that power generating operation is required. Thus, in the cooling system 1, when cooling and power generation are required, it is possible to exert the cooling function and the power generating function by driving the fuel circulating pump 14. In other words, it is possible to exert an on-demand function by which these functions are exerted upon requirement.

Further, the control means may perform variable control on the output value of the fuel circulating pump 14 according to the temperature of the apparatus 30 to be cooled or the power to be output from the power generation stack 20. By thus controlling the output (driving power) of the fuel circulating pump 14, it is possible to control the temperature of the apparatus 30 to be cooled so as to keep it not higher than a fixed value, and to set the power generation amount of the power generation stack 20 a desired value.

Further, in this embodiment, as the electrolyte of the power generation stack 20, a polymer electrolyte membrane is used, whereby the power generation stack 20 can constitute a polymer electrolyte fuel cell (PEFC).

(Electronic Apparatus)

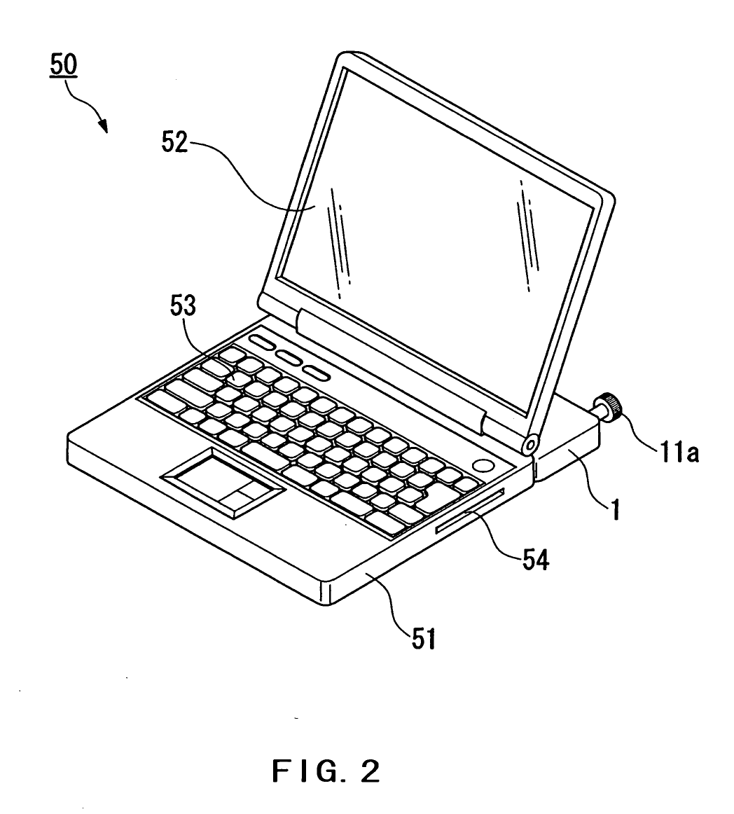

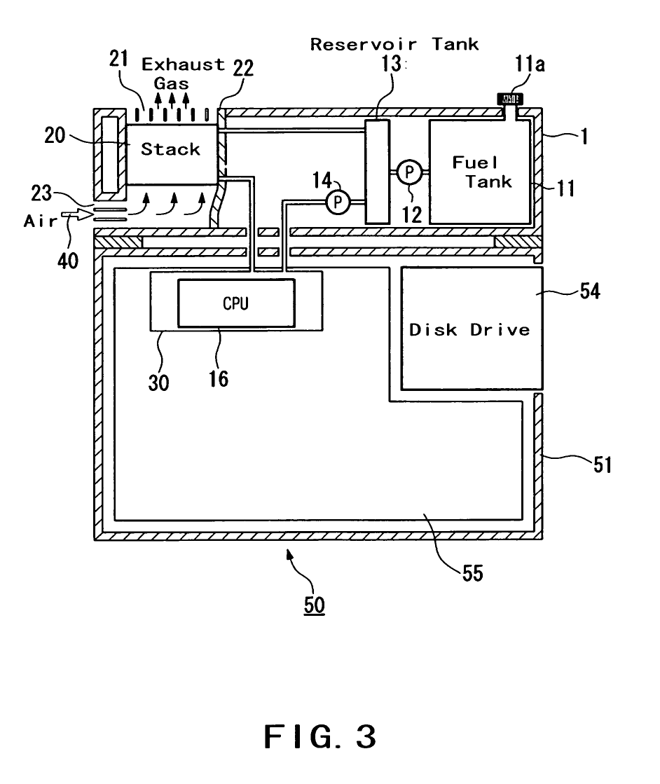

FIG. 2 is a perspective view of an outward appearance of an electronic apparatus according to the first embodiment of the present invention. FIG. 3 is a schematic sectional view of the inner construction of the electronic apparatus shown in FIG. 2. An electronic apparatus 50 according to this embodiment includes the cooling system 1 shown in FIG. 1 as a component. In FIGS. 2 and 3, the components that are the same as those of FIG. 1 are indicated by the same reference numerals.

The electronic apparatus 50 includes a notebook personal computer. The electronic apparatus 50 has the cooling system 1, a main body portion 51, a display portion 52, a keyboard portion 53, and a disk drive 54. The cooling system 1 constitutes a fuel cell unit, which is detachably mounted to the main body portion 51. Thus, it is possible to detach the cooling system 1 from the main body portion 51 and to use it as a conventional, ordinary notebook personal computer. Further, when, for example, the cooling system 1 is out of order, it is possible to mount a new cooling system 1 to the main body portion 51.

The main body portion 51 constitutes the main body of the electronic apparatus 50 consisting of a notebook personal computer, and has the disk drive 54 and a motherboard 55. The disk drive 54 is used to write and read data to and from a flexible disk, a magneto-optical disk, a CD, a DVD, or the like. The motherboard 55 includes a single board on which there are mounted a basic device group constituting a computer system and consisting of semiconductor chips, such as a CPU, a memory, a BIOS (basic input output system), and an extension slot. The heat collector 16 of the cooling system 1 is also mounted on the motherboard 55.

In the electronic apparatus 50, the apparatus 30 to be cooled is the CPU of the notebook personal computer. Further, the heat collector 16 is arranged in the vicinity of the apparatus 30 to be cooled. That is, solely the heat collector 16 in the cooling system 1 and the piping connected to the heat collector 16 are arranged in the main body portion 51. Here, the apparatus 30 to be cooled may also include a chip set constituting the peripheral circuit of the CPU. Further, the power generation stack 20 of the cooling system 1 may constitute the power source of the electronic apparatus 50. An external circuit 60, shown in. FIG. 1, may be the main body portion 51, the display portion 52, etc. including the apparatus 30 to be cooled in FIGS. 2 and 3.

Further, the cooling system 1 of the electronic apparatus 50 has an exhaust port 21, a partition wall 22, and an intake port 23. Air 40 flows from the intake port 23 to the power generation stack 20, and carbon dioxide (and water) generated in the power generation stack 20 is discharged through the exhaust port 21. The partition wall 22 is a heat insulating member for preventing the heat generated in the power generation stack 20 from being conducted to the reservoir tank 13, the main body portion 51, etc. A fan or the like may be mounted at the intake port 23.

Further, the electronic apparatus 50 may have a storage battery (battery) for storing the power generated in the power generation stack 20. At the initial stage of the operation of the circuit of the notebook personal computer including the apparatus 30 to be cooled (e.g., for several minutes from the turning ON of the main switch of the electronic apparatus 50), power is supplied to the circuit from the storage battery, and, thereafter, when the power generation stack 20 starts to generate power in a stable manner, power may be supplied from the power generation stack 20 to the storage battery and the circuit. Here, it is also possible to adopt an arrangement in which, simultaneously with the turning ON of the main switch, the fuel circulating pump 14 is driven by the power of the storage battery, starting the cooling function of the cooling system 1 and the power generating function. In this arrangement, it is possible to cool the apparatus 30 to be cooled simultaneously with the starting of the apparatus 30 to be cooled, such as the CPU, and to perform power generation by the power generation stack 20 substantially simultaneously therewith.

Thus, the electronic apparatus 50, which is equipped with a fuel cell as the power source, can be driven with high energy efficiency, and provides an apparatus friendly to the environment, its exhaust gas being clean. Further, the electronic apparatus 50, which is equipped with a fuel cell as the power source, involves very little noise, and can be driven for a long period of time without being charged while being compact, thus providing an apparatus suitable as a portable apparatus.

Further, the electronic apparatus 50, which is equipped with a fuel cell as the power source, can cool the heat generating component, such as the CPU, by the fuel 10 of the fuel cell. Thus, the electronic apparatus 50 has a power generating means and a cooling means, and is compact and capable of promoting an increase in speed and in scale of integration, making it possible to provide a high-performance and inexpensive notebook personal computer.

The technical scope of the present invention is not restricted to the above-described embodiment but allows various modifications without departing from the gist of the present invention. The specific materials, layer structure, etc. of the embodiment are only given by way of example, and various modifications are possible.

For example, the electronic apparatus of the above embodiment is not restricted to a personal computer, but is also applicable to various electronic apparatuses, such as a mobile phone, a PDA (personal digital assistance), a camera, a watch, an overhead projector, and an automotive electronic control circuit. Further, the object of application of the cooling system 1 of the present invention is not restricted to an electronic apparatus; as the apparatus 30 to be cooled, various apparatuses, such as an automotive engine itself or a power generating device motor itself, can be applied, thus allowing application to various types of mechanical and electric apparatus.

In the electronic apparatus 50 of the above embodiment, when the fuel 10 in the fuel tank 11 has been consumed, it is possible to supply fuel through the inlet port 11a of the fuel tank 11. Further, when the fuel tank 11 is detachably mounted to the cooling system 1, and the fuel 10 in the fuel tank 11 has been consumed, the fuel tank 11 itself may be replaced by another fuel tank 11 fully filled with fuel.

Further, the electronic apparatus 50 of the above embodiment may have a DC-DC converter that converts the voltage of the electric power output from the power generation stack 20 of the cooling system 1. The heat generating element of this DC-DC converter may serve as the apparatus 30 to be cooled mentioned above.

Further, in the cooling system 1 of the above embodiment, it is also possible to provide a plurality of heat collectors 16, and one of the heat collectors 16 may cool the power generation stack 20 as the apparatus 30 to be cooled.

### SECOND EMBODIMENT OF THE INVENTION

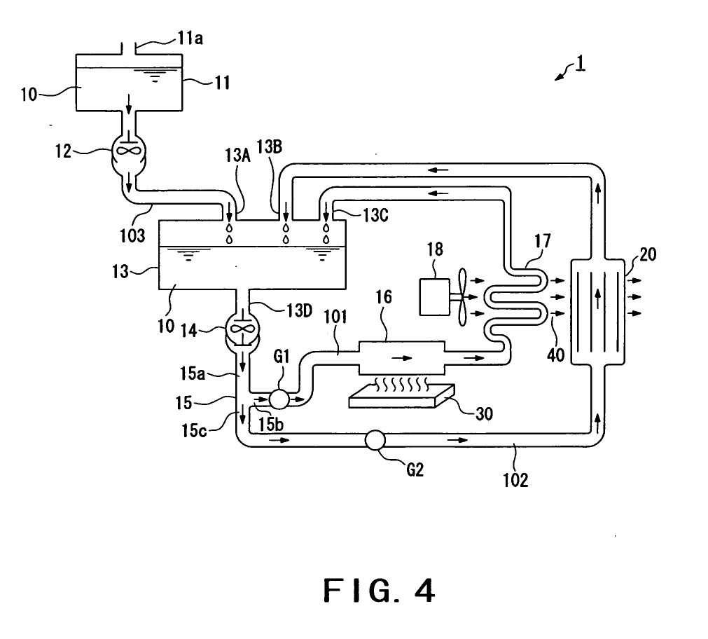

FIG. 4 is a conceptual drawing showing the construction of a cooling system according to a second embodiment of the present invention. The components that are the same as those of the first embodiment are indicated by the same reference numerals. A cooling system 111 according to this embodiment uses the fuel of a fuel cell as the cooling medium. The cooling system 111 has a power generating means using a fuel cell, and a cooling means using fuel 10 of the fuel cell as the cooling medium. The construction of this cooling system will be specifically described below.

The cooling system 111 has a fuel tank 11, a fuel supply pump 12, a reservoir tank 13, a fuel circulating pump 14, a branching portion 15, a heat collector 16, a radiator 17, an air blower 18, and a power generation stack 20. The cooling system 111 has a cooling flow passage 101, a power generation flow passage 102, a supply flow passage 103, a first valve G1 arranged in the cooling flow passage, and a second valve G2 arranged in the power generation flow passage.

Here, the cooling flow passage 101 constitutes the flow passage for supplying fuel to the heat collector 16, and the fuel 10 passes through this flow passage as the cooling medium. In the cooling flow passage 101, there are arranged the first valve G1, the heat collector 16, and the radiator 17 in series in that order from the upstream side. The heat generation flow passage 102 constitutes the flow passage for supplying the fuel 10 to the power generation stack. In the power generation flow passage 102, there are arranged the second valve G2 and the power generation stack 20 in series in that order from the upstream side. The fuel 10 passing through the cooling flow passage 101 and the fuel 10 passing through the power generation flow passage 102 are the same fuel, that is, the fuel 10 stored in the reservoir tank 13.

The cooling flow passage 101 and the upstream side portion of the power generation flow passage 102 are connected together by the branching portion 15, and the cooling flow passage 101 and the downstream side portion of the power generation flow passage 102 are connected together by the reservoir tank 13. Thus, the cooling flow passage 101 and the power generation flow passage 102 are provided in parallel. Further, the downstream side of the reservoir tank 13 is connected to the fuel circulating pump 14, and the downstream side of the fuel circulating pump 14 is connected to the branching portion 15. Due to this construction, the fuel 10 supplied from the reservoir tank 13 flows by way of the fuel circulating pump 14, the branching portion 15, and the cooling flow passage 101 (including the first valve G1, the heat collector 16, and the radiator 17) and returns to the reservoir tank 13. In other words, the cooling flow passage 101 constitutes a part of the circulation flow passage for the fuel 10 used as the cooling medium at the heat collector 16. Further, the fuel 10 supplied from the reservoir tank 13 flows by way of the fuel circulating pump 14, the branching portion 15, and the power generation flow passage 102 (including the second valve G2 and the power generation stack 20) and returns to the reservoir tank 13. In other words, the power generation flow passage 102 constitutes a part of the circulation flow passage through which the fuel 10 circulates passing through the power generation stack. Next, the components of the cooling system 111 different from those of the first embodiment will be described.

The fuel supply pump 12 is arranged in the supply flow passage 103 connecting the fuel tank 11 and the reservoir tank 13. The fuel supply pump 12 is a pump that supplies the fuel 10 in the fuel tank 11 to the reservoir tank 13. The operation of the fuel supply pump 12 is controlled by a control means (not shown) of the cooling system 111. When, for example, the level of the fuel 10 in the reservoir tank 13 becomes not higher than a predetermined value, the control means drives the fuel supply pump 12, and moves the fuel 10 from the fuel tank 11 to the reservoir tank 13.

The reservoir tank 13 is a tank that temporarily stores the fuel 10 supplied from the fuel tank 11. The reservoir tank 13 constitutes a part of the circulation flow passage (the circulation flow passage partially formed by the cooling flow passage 101, and the circulation flow passage partially formed by the heat generation flow passage 102) for the fuel 10 in the cooling system 111. More specifically, the reservoir tank 13 has three inflow portions 13A, 13B, and 13C, and one outflow portion 13D. The inflow portion 13A constitutes the inlet port for the fuel 10 supplied from the fuel tank 11 through the fuel supply tank 12. The outflow portion 13D constitutes the outlet port for the fuel 10 stored in the reservoir tank 13. The inflow portion 13B constitutes a first inlet port according to the present invention; it is connected to the downstream end of the cooling flow passage 101, constituting the inlet port for the fuel 10 supplied from the radiator 17. The inflow portion 13C constitutes a second inlet port according to the present invention; it is connected to the downstream end of the power generation flow passage 102, constituting the inlet port for the fuel 10 supplied from the power generation stack 20.

The fuel circulating pump 14 is a pump that circulates the fuel 10 through the cooling flow passage 101 and the power generation flow passage 102. The inlet port of the fuel circulating pump 14 is connected to the outflow portion 13D of the reservoir tank 13. The branching portion 15 branches off the fuel output from the fuel circulating pump 14 in two directions. Further, the branching portion 15 has an inlet port 15a, a first branching end 15b, and a second branching end 15c. The inlet port 15a of the branching portion 15 is connected to the outlet port of the fuel circulating pump 14. The first branching end 15b of the branching portion 15 is connected to the upstream end of the cooling flow passage 101, that is, the inlet port of the first valve G1. The second branching end 15c of the branching portion 15 is connected to the upstream end of the power generation flow passage 102, that is, the inlet port of the second valve G2.

Due to this construction, the fuel 10 in the reservoir tank 13 is sent to the branching portion 15 by the fuel circulating pump 14, branched off at the branching portion 15 into the cooling flow passage 101 and the power generation flow passage 102, and passes through the cooling flow passage 101 and the power generation flow passage 102 before returning to the reservoir tank 13.

The first valve G1 supplies or ceases to supply the fuel 10 to the cooling flow passage 101. The second valve G2 supplies or ceases to supply the fuel 10 to the power generation flow passage 102. As the first valve G1 and the second valve G2, ones capable of opening/closing operation will serve the purpose; they may also be ones capable of performing variable control on the flow rate of the fuel 10 stepwise or smoothly. Further, the first valve G1 and the second valve G2 may be ones that allow adjustment of opening/closing or aperture through direct manual operation or ones that allow adjustment of opening/closing or aperture through mechanical or electronic control means.

The heat collector 16 constitutes a heat absorbing device (heat exchanger for heat absorption) using the fuel 10 as the cooling medium. The heat collector 16 is arranged in the vicinity of the apparatus 30 to be cooled, and may be in close contact with the apparatus 30 to be cooled. The apparatus 30 to be cooled is an apparatus to be cooled by the cooling system 1, and consists, for example, of a heat generating device, such as the CPU of a personal computer or of a mobile phone. The apparatus 30 to be cooled is not restricted to a CPU; an integrated circuit of high density and high operation speed, a component of a projector constituting a display device, a mechanical component of a vehicle engine, etc. are also applicable.

The radiator 17 serves to dissipate the heat of the fuel 10 passing through the cooling flow passage 101. That is, the fuel 10 heated at the heat collector 16 is cooled by the radiator 17. The radiator 17 may be of any type as long as it dissipates the heat of the fuel 10, and various types of radiator are applicable. Further, it is desirable for the radiator 17 to be arranged in the vicinity of the power generation stack 20.

The air blower 18 constitutes a fan, which supplies air to the radiator 17 to forcibly cool it. It is desirable for the power generation stack 20 to be arranged on the downstream side of the radiator 17 with respect to the flow of the air 40 generated by the air blower 18.

The power generation stack 20 constitutes a fuel cell using the fuel 10 as its fuel. That is, various type of fuel cell are applicable as the power generation stack 20 as long as they constitute fuel cells. When a direct methanol type fuel cell (DMFC) is used as the power generation stack 20, the following construction can be adopted. The power generation stack 20 includes a cell stack formed by stacking together a plurality of cells in each of which both sides of an electrolyte are sandwiched between a negative electrode and a positive electrode and these components are bonded together, an aqueous solution of methanol being supplied to the negative electrodes as the liquid fuel 10, the air 40 as the oxidant gas being supplied to the positive electrodes. Further, inserted between the cells are separators having flow passage grooves and manifolds for discharging the reaction product generated through the electrochemical reaction in the cells.

The fuel 10 (aqueous solution of methanol) is supplied to the negative electrodes of the cells of the power generation stack 20 and the air 40 is supplied to the positive electrodes of the cells of the power generation stack 20. Then, at the negative electrodes, methanol reacts with water to produce carbon dioxide, and at the positive electrodes, the oxygen in the air 40 takes in hydrogen ions and electrons passed through the electrolytes to thereby produce water, thus generating electrical energy between the positive electrodes and the negative electrodes (i.e., power generation is effected). This electrical energy is output to an external circuit (not shown) electrically connected between the positive and negative electrodes. Any surplus fuel 10 in the power generation stack 20, that is, the portion of the fuel 10 that has not been used for power generation, is supplied to the reservoir tank 13.

Due to this arrangement, in the cooling system 111 of this embodiment, it is possible to cool the apparatus 30 to be cooled arranged in the vicinity of the heat collector 16 by using the fuel 10 of the fuel cell as the cooling medium. In the cooling system 111, the apparatus 30 to be cooled is cooled by the fuel 10 of the fuel cell, and, while doing so, it is possible to effect power generation in the power generation stack 20 by using the same fuel 10. Thus, in the cooling system 111, the same fuel can be used as both the fuel 10 constituting the cooling medium and the fuel 10 of the fuel cell, and the reservoir tank 13 and the fuel circulating pump 14 constituting a part of the circulation flow passage can be shared by the cooling means and the power generating means. Further, in the cooling system 111, the fuel tank 11 and the fuel supply pump 12 can be shared by the cooling means and the power generating means. Thus, while having a power generating means and a cooling means, the cooling system 111 can be of a compact construction, making it possible to achieve a reduction in installation space. Further, as stated above, in the cooling system 111, the fuel.10, the fuel tank 11, the reservoir tank 13, the fuel circulating pump 14, etc. can be shared by the power generating means and the cooling means, so that it is possible to reduce the energy loss etc. for transporting the fuel, thereby achieving an improvement in terms of energy efficiency.

Further, in the cooling system 111 of this embodiment, the power generation stack 20 is arranged on the downstream side of the radiator 17 with respect to the flow of the air 40 generated by the air blower 18, so that the air blower 18 can be shared by the radiator 17 and the power generation stack 20, and it is possible to supply the air 40 heated by the radiator 17 to the power generation stack 20. Thus, in the cooling system 111, the power generation stack 20 can be heated by the heat emitted from the radiator 17, whereby it is possible to improve the power generation efficiency of the power generation stack 20. Generally speaking, the power generation stack 20 performs power generation in a stable manner at a temperature higher than room temperature, so that it is also possible for the cooling system 111 to shorten the power generation start time of the power generation stack 20. To obtain generated power in a stable manner from the power generation stack 20, it is desirable, in the case of a direct methanol type fuel cell, to operate the power generation stack 20 at an ambient temperature ranging from 30 to 90° C.

Further, in the cooling system 111 of this embodiment, when there is no need to cool the apparatus 30 to be cooled, it is also possible to close the first valve G1 and open the second valve G2, causing all the fuel 10 supplied from the fuel circulating pump 14 to flow through the power generation flow passage 102. This makes it possible to increase the power generation output in the power generation stack 20 as compared with the case in which the first valve G1 and the second valve G2 are opened. Further, in the cooling system 111, when there is no need to cool the apparatus 30 to be cooled nor is there any need for the generated power to be particularly large, the first valve G1 is closed and the second valve G2 is opened, and, at the same time, the driving power for the fuel circulating pump 14 can be reduced. As a result, it is possible to reduce the power consumption at the fuel circulating pump 14, thus making it possible to achieve an improvement in terms of energy efficiency. Further, in the cooling system 111, when there is no need to effect power generation, the first valve G1 is opened and the second valve G2 is closed, whereby it is possible to use almost all the fuel 10 supplied from the fuel circulating pump 14 as the cooling medium, thus making it possible to enhance the cooling capacity. Further, in the cooling system 111, when there is no need to effect power generation nor is there any need for the cooling capacity to be particularly large, the first valve G1 is opened, and the second valve G2 is closed, and, at the same time, the driving power for the fuel circulating pump 14 can be reduced.

Further, in this embodiment, by using a polymer electrolyte membrane as the electrolyte of the power generation stack 20, it is possible for the power generation stack 20 to form a polymer electrolyte fuel cell (PEFC).

(Electronic Apparatus)

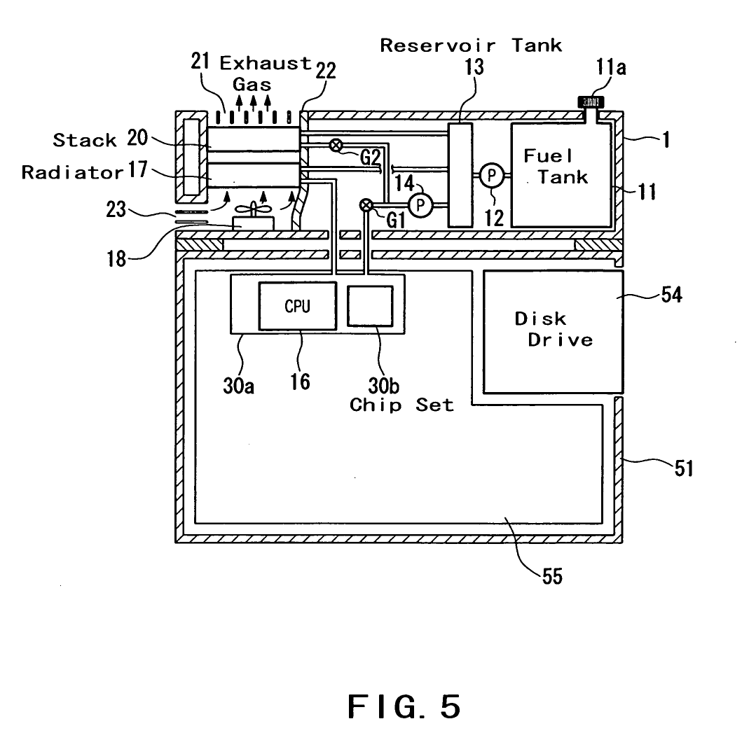

The outward appearance of an electronic apparatus according to the second embodiment of the present invention is as shown in FIG. 2, which is a perspective view. FIG. 5 is a schematic sectional view of the inner construction of the electronic apparatus shown in FIG. 2. An electronic apparatus 150 of this embodiment includes the cooling system 111 shown in FIG. 4 as a component. In FIGS. 2 and 5, the components that are the same as those shown in FIG. 4 are indicated by the same reference numerals.

In the electronic apparatus 150, the apparatus 30 to be cooled includes a CPU 30a and a chip set 30b of a notebook personal computer. The chip set 30b has a circuit for controlling data passed through various buses for I/O, for example, between the CPU 30a and chips in the periphery thereof. Further, the chip set 30b may include a plurality of LSIs having functions related to the CPU 30a and necessary for the motherboard 55. For example, the chip set 30b may include a timer, an interrupt control circuit, a DMA (direct memory access) circuit, a memory control circuit, a bus interface, etc.

Further, the CPU 30a and the chip set 30b are arranged on the surface of the heat collector 16. Further, as shown in FIG. 5, solely the heat collector 16 of the cooling system 111 and the piping connected to the heat collector 16 are arranged inside the main body portion 51. Further, the power generation stack 20 of the cooling system 111 may constitute the power source of the electronic apparatus 150.

The cooling system 111 of the electronic apparatus 50 has an exhaust port 21, a partition wall 22, and an intake port 23. Air 40 enters through the intake port 23, and flows to the radiator 17, from which it flows to the power generation stack 20. Then, the power generation stack 20 produces carbon dioxide (and water), and the carbon dioxide (and water) are discharged through the exhaust port 21. The partition wall 22 is a heat insulating member for preventing the heat generated in the power generation stack 20 from being conducted to the reservoir tank 13, the main body portion 51, etc.

Further, the electronic apparatus 150 may have a storage battery (battery) for storing the power generated in the power generation stack 20. At the initial stage of the operation of the circuit of the notebook personal computer including the apparatus 30 to be cooled (e.g., for several minutes from the turning ON of the main switch of the electronic apparatus 150), power is supplied to the circuit from the storage battery, and, thereafter, when the power generation stack 20 starts to generate power in a stable manner, power may be supplied from the power generation stack 20 to the storage battery and the circuit. Here, it is also possible to adopt an arrangement in which, simultaneously with the turning ON of the main switch, the fuel circulating pump 14 is driven by the power of the storage battery, starting the cooling function of the cooling system 111 and the power generating function. This makes it possible to operate the electronic apparatus 150 with the power of the storage battery until the power generation stack 20 generates power in a stable manner, and to substantially reduce the capacitance of the storage battery as compared with that of conventional notebook personal computers.

Thus, the electronic apparatus 150, which is equipped with a fuel cell as the power source, can be driven with high energy efficiency, and provides an apparatus friendly to the environment, its exhaust gas being clean. Further, the electronic apparatus 150, which is equipped with a fuel cell as the power source, involves very little noise, and can be driven for a long period of time without being charged while being compact, thus providing an apparatus suitable as a portable apparatus.

Further, the electronic apparatus 150, which is equipped with a fuel cell as the power source, can cool the heat generating components, such as the CPU 30a and the chip set 30b, by the fuel 10 of the fuel cell. Thus, the electronic apparatus 150 has a power generating means and a cooling means, and is compact and capable of promoting an increase in speed and in scale of integration, making it possible to provide a high-performance and inexpensive notebook personal computer.

The technical scope of the present invention is not restricted to the above-described embodiment but allows various modifications without departing from the gist of the present invention. The specific materials, layer structure, etc. of the embodiment are only given by way of example, and various modifications are possible.

For example, the electronic apparatus of the above embodiment is not restricted to a personal computer, but is also applicable to various electronic apparatuses, such as a mobile phone, a PDA (personal digital assistance), a camera, a watch, a projector, and an automotive electronic control circuit. Further, the object of application of the cooling system 111 of the present invention is not restricted to an electronic apparatus; as the apparatus 30 to be cooled, various apparatuses, such as an automotive engine itself or a power generating device motor itself, can be applied, thus allowing application to various types of mechanical and electric apparatus.

In the electronic apparatus 150 of the above embodiment, when the fuel 10 in the fuel tank 11 has been consumed, it is possible to supply fuel through an inlet port 11a of the fuel tank 11. Further, when fuel tank 11 is a cartridge type which is detachably mounted to the cooling system 111, and the fuel 10 in the fuel tank 11 has been consumed, the fuel tank 11 itself may be replaced by another fuel tank 11 filled with fuel.

Further, the electronic apparatus 150 of the above embodiment may have a DC-DC converter that converts the voltage of the electric power output from the power generation stack 20 of the cooling system 111. Further, the heat generating element of this DC-DC converter may serve as the apparatus 30 to be cooled mentioned above.

Further, in the cooling system 111 of the above embodiment, it is also possible to provide a plurality of heat collectors 16 and a plurality of radiators 17, and one of the heat collectors 16 may cool the power generation stack 20 as the apparatus 30 to be cooled.

1. A cooling system which uses a liquid constituting a fuel of a fuel cell as a cooling medium.

2. A cooling system according to claim 1, comprising:
a heat collector using the fuel as the cooling medium;
a power generation stack constituting the fuel cell; and
a fuel flow passage which constitutes a flow passage for the fuel and which connects at least the heat collector and the power generation stack.

3. A cooling system according to claim 2, further comprising a pump which moves the fuel in the fuel flow passage.

4. A cooling system according to claim 2, wherein the heat collector is arranged on the upstream side of the power generation stack with respect to a fuel flow in the fuel flow passage.

5. A cooling system according to claim 3, further comprising a control means which controls an operation of the pump,
wherein, when a cooling operation by the heat collector is required, the control means drives the pump.

6. A cooling system according to claim 2, further comprising a reservoir tank that stores the fuel,
wherein the fuel passage constitutes a flow passage connecting the reservoir tank, the heat collector, and the power generation stack in series, and constitutes a circulation flow passage that causes the fuel to circulate through the reservoir tank, the heat collector, and the power generation stack.

7. A cooling system according to claim 6, further comprising:
a fuel tank that stores the fuel supplied to the reservoir tank;
a supply flow passage connecting the fuel tank and the reservoir tank; and
a supply pump arranged in the supply flow passage.

8. An electronic apparatus comprising the cooling system as claimed in claim 1.

9. An electronic apparatus comprising the cooling system as claimed in claim 2.

10. An electronic apparatus according to claim 8, comprising:
an apparatus to be cooled that is arranged in the vicinity of the heat collector; and
an electronic device that is operated by using an electric power output from the power generation stack.

11. An electronic apparatus according to claim 9, comprising:
an apparatus to be cooled that is arranged in the vicinity of the heat collector; and
an electronic device that is operated by using an electric power output from the power generation stack.

12. An electronic apparatus according to claim 10, wherein the apparatus to be cooled and the electronic device are the same member.

13. An electronic apparatus according to claim 11, wherein the apparatus to be cooled and the electronic device are the same member.

14. An electronic apparatus according to claim 8, wherein the cooling system is detachably mounted to a main body of the electronic apparatus.

15. An electronic apparatus according to claim 9, wherein the cooling system is detachably mounted to a main body of the electronic apparatus.

16. A cooling method comprising using a fuel of a fuel cell as a cooling medium.

17. A cooling method according to claim 16, wherein the fuel, which is used as the cooling medium and heated, is supplied to a power generation stack constituting the fuel cell.

18. A cooling method according to claim 17, wherein the fuel is circulated through a heat collector using the fuel as the cooling medium and through the power generation stack.

19. A cooling system which uses a fuel of a fuel cell as a cooling medium, comprising:
a heat collector through which the fuel passes as the cooling medium;
a cooling flow passage constituting a flow passage for supplying the fuel to the heat collector;
a power generation stack to which the fuel is supplied and which constitutes the fuel cell; and
a power generation flow passage constituting a flow passage for supplying the fuel to the power generation stack.

20. A cooling system according to claim 19, wherein the cooling flow passage and the power generation flow passage are provided in parallel.

21. A cooling system according to claim 19, further comprising a radiator arranged on the downstream side of the heat collector in the cooling flow passage,
wherein the radiator is arranged in the vicinity of the power generation stack.

22. A cooling system according to claim 19, further comprising:
a pump that moves the fuel; and
a branching portion that branches off the fuel moved by the pump in at least two directions,
wherein an upstream end of the cooling flow passage is connected to a first branching end of the branching portion, and
wherein an upstream end of the power generation flow passage is connected to a second branching end of the branching portion.

23. A cooling system according to claim 19, wherein the cooling flow passage constitutes all or a part of a circulation flow passage through which the fuel is circulated at least through the heat collector, and
wherein the power generation flow passage constitutes all or a part of a circulation flow passage through which the fuel is circulated at least through the power generation stack.

24. A cooling system according to claim 22, further comprising a reservoir tank storing the fuel and equipped with an outlet port through which the fuel stored flows out,
wherein the outlet port of the reservoir tank is connected to an inlet port of the pump.

25. A cooling system according to claim 24, wherein the reservoir tank has a plurality of inlet ports,
wherein a downstream end of the cooling flow passage is connected to a first inlet port of the reservoir tank, and
wherein a downstream end of the power generation flow passage is connected to a second inlet port of the reservoir tank.

26. A cooling system according to claim 21, further comprising an air blower that supplies air to the radiator,
wherein the power generation stack is arranged on the downstream side of the radiator with respect to an airflow generated by the air blower.

27. A cooling system according to claim 19, further comprising:
a first valve arranged in the cooling flow passage; and
a second valve arranged in the power generation flow passage.

28. A cooling system according to claim 27, wherein the first valve is arranged on the upstream side of the heat collector in the cooling flow passage, and
wherein the second valve is arrange on the upstream side of the power generation stack in the power generation flow passage,
the cooling system further comprising a control means that controls the opening and closing of the first valve and the second valve,
wherein, when cooling by the heat collector is not required, the control means closes the first valve, and when power generation by the power generation stack is not required, the control means closes the second valve.

29. A cooling system according to claim 24, further comprising:
a fuel tank that stores the fuel to be supplied to the reservoir tank;
a supply flow passage connecting the fuel tank and the reservoir tank; and
a supply pump arranged in the supply flow passage.

30. An electronic apparatus comprising the cooling system as claimed in claim 19.

31. An electronic apparatus according to claim 30, further comprising:
an apparatus to be cooled arranged in the vicinity of the heat collector; and
an electronic device operating by using an electric power output from the power generation stack.
